(19) United States
(12) Patent Application Publication
(10) Pub. No.: US 2025/0088284 A1
(43) Pub. Date: Mar. 13, 2025

(54) Optical Linearization Technique

(71) Applicant: AyDeeKay LLC dba Indie Semiconductor, Aliso Viejo, CA (US)

(72) Inventors: Facundo Picco, Aliso Viejo, CA (US); Iván Dipre, Aliso Viejo, CA (US)

(73) Assignee: AyDeeKay LLC dba Indie Semiconductor, Aliso Viejo, CA (US)

(21) Appl. No.: 18/827,571

(22) Filed: Sep. 6, 2024

Related U.S. Application Data
(60) Provisional application No. 63/537,193, filed on Sep. 7, 2023.

(51) Int. Cl. H04B 10/58

(52) U.S. Cl. CPC H04B 10/58

(57) ABSTRACT

An integrated circuit is described. This integrated circuit may include an optical transmit circuit that outputs optical signals (such as optical pulses or FMCW optical signals) having a carrier-frequency (or chirp) pattern as a function of time, where a modulation signal, associated with an optical source and corresponding to the carrier-frequency pattern, includes a predistortion to reduce a nonlinearity associated with the optical transmit circuit. Moreover, the integrated circuit may include a feedback circuit that measures the nonlinearity (e.g., using an interferometer) and that dynamically adjusts the predistortion based at least in part on the measured nonlinearity. Note that the integrated circuit may provide closed-loop adjustment of the predistortion. In some embodiments, the correction of the nonlinearity may be performed in the frequency domain.

### CROSS REFERENCE TO RELATED APPLICATIONS

This application claims priority under 35 U.S.C. 119 (e) to U.S. Provisional Application Ser. No. 63/537,193, entitled “Optical Linearization Technique,” by Facundo Picco, et al., filed on Sep. 7, 2023, the contents of which are herein incorporated by reference.

### FIELD

The present disclosure relates to techniques for determining predistortion of a modulation signal corresponding to a carrier-frequency pattern of a chirped transmit signal in order to linearize an optical measurement device or system (such as a light detection and ranging or lidar measurement device or system).

### BACKGROUND

Lidar uses optical signals to measure relative positions and velocities of one or more objects in an environment. The use of narrow widths of the optical beams in lidar measurements can reduce the amount of clutter or transient signals in measurements. However, the use of higher carrier frequencies in lidar measurements typically increases the Doppler effect and results in a mixture of signals associated with relative positions and velocities. Moreover, the high frequencies used in lidar usually imply a tight constraint on the linearity of components in the measurement systems. For example, an error of a few tens or hundreds of kiloHertz in a 100 teraHertz carrier frequency corresponds to an error that is less than parts per million (ppm). Furthermore, the nonlinearity constraint is typically determined over the modulation bandwidth.

### SUMMARY

Embodiments of an integrated circuit are described. This integrated circuit includes an optical transmit circuit that outputs optical signals having a carrier-frequency (or chirp) pattern as a function of time, where a modulation signal, associated with an optical source and corresponding to the carrier-frequency pattern, includes a predistortion to reduce a nonlinearity associated with the optical transmit circuit. Moreover, the integrated circuit includes a feedback circuit that measures the nonlinearity and that dynamically adjusts the predistortion based at least in part on the measured nonlinearity.

Note that the integrated circuit may provide closed-loop adjustment of the predistortion.

Moreover, the predistortion may include direct modulation of a current or voltage associated with the modulation signal, such as a current or voltage applied to the optical source (such as a laser) in the optical transmit circuit.

In some embodiments, the integrated circuit may provide closed-loop adjustment of the predistortion.

Furthermore, the feedback circuit may measure a carrier frequency of the output optical signals as a function of time.

Additionally, the feedback circuit may include an interferometer.

In some embodiments, at least a portion of the dynamic adjustment may be performed in the frequency domain. Moreover, the feedback circuit may compare at least a portion of a band of frequencies associated with a Fourier Transform (such as a Fast Fourier Transform or FFT) of the output optical signals to a target waveform (or pattern). Furthermore, the feedback circuit may adjust the predistortion so that a time average of the comparison is zero. For example, the adjustment of the predistortion may be performed on a bin-by-bin or frequency interval-by-frequency interval basis.

Another embodiment provides an electronic device that includes the integrated circuit.

Another embodiment provides a system that includes the integrated circuit.

Another embodiment provides a method for closed-loop adaptation of a modulation signal associated with an optical source and corresponding to a carrier-frequency pattern of optical signals provided by an optical transmit circuit. This method includes at least some of the operations performed by the integrated circuit.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1A is a block diagram illustrating a circuit diagram of an optical transmit circuit according to some embodiments of the present disclosure.

FIG. 1B is a block diagram illustrating a circuit diagram of an optical transmit circuit according to some embodiments of the present disclosure.

FIG. 2 is a flow diagram illustrating an example of a method for closed-loop adaptation of a modulation signal associated with an optical source and corresponding to a carrier-frequency pattern of optical signals according to some embodiments of the present disclosure.

Note that like reference numerals refer to corresponding parts throughout the drawings. Moreover, multiple instances of the same part or component may be designated by a common prefix separated from an instance number by a dash.

### DETAILED DESCRIPTION

An integrated circuit is described. This integrated circuit may include an optical transmit circuit that outputs optical signals (such as optical pulses or continuous-wave optical signals) having a carrier-frequency (or chirp) pattern as a function of time, where a modulation signal, associated with an optical source and corresponding to the carrier-frequency pattern, includes a predistortion to reduce a nonlinearity associated with the optical transmit circuit. Moreover, the integrated circuit may include a feedback circuit that measures the nonlinearity (e.g., using an interferometer) and that dynamically adjusts the predistortion based at least in part on the measured nonlinearity. Note that the integrated circuit may provide closed-loop adjustment of the predistortion. In some embodiments, the correction of the nonlinearity may be performed in the frequency domain.

By dynamically adjusting the predistortion of the modulation signal, these circuit techniques may allow the integrated circuit to have improved performance. Notably, the integrated circuit may reduce or eliminate the nonlinearity associated with the optical transmit circuit. For example, the circuit techniques may reduce or eliminate changes in the nonlinearity associated with changes to ambient temperature and/or aging of one or more components in the optical transmit circuit. More generally, the integrated circuit may reduce or eliminate the nonlinearity associated with the optical transmit circuit. Consequently, the circuit techniques may facilitate the increased use of the integrated circuit in a wide variety of systems, electronic devices and applications. For example, the integrated circuit may be used in semi-autonomous and/or autonomous or self-driving vehicles.

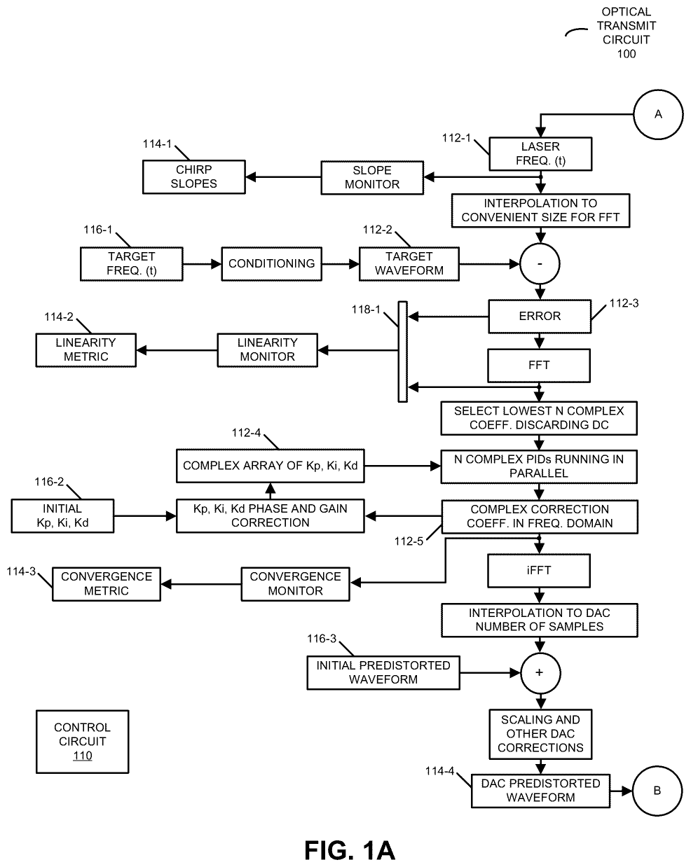

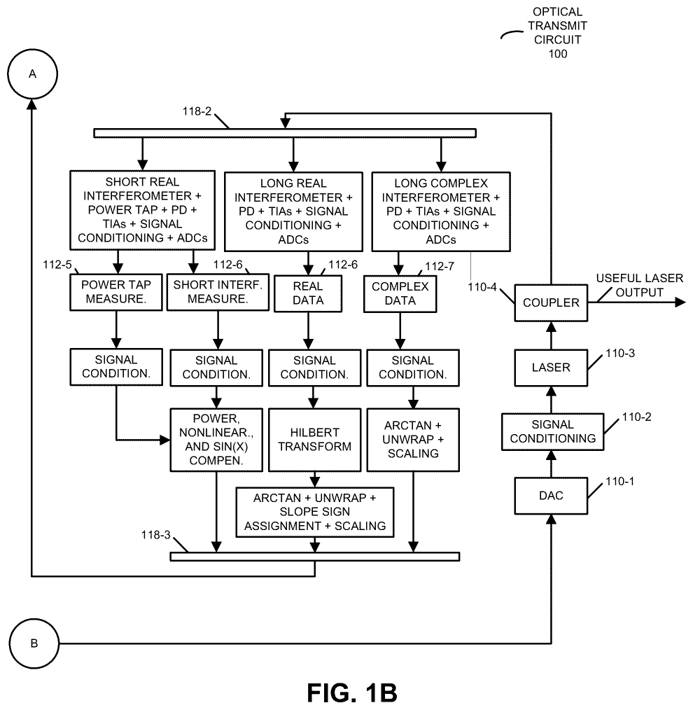

We now describe embodiments of the circuit techniques. These circuit techniques may be performed using one or more integrated circuits. The one or more integrated circuits may include some or all of the described components and associated functionality. FIGS. 1A and 1B present a block diagram illustrating a circuit diagram of an optical transmit circuit 100.

Optical transmit circuit 100 may provide or output optical transmit signals. These optical transmit signals may have carrier frequencies that are changed as a function of time based at least in part on a modulation signal, associated with an optical source and corresponding to a carrier-frequency pattern. For example, the optical transmit signals may include frequency modulated continuous wave (FMCW) signals. However, in other embodiments, the optical transmit signals may include pulsed signals. In the discussion that follows, FMCW optical transmit signals are used as an illustrative example.

Thus, the lidar measurements may use a chirped signal in which the carrier frequency of the transmit optical signals is varied as a function of time. For example, the carrier frequency may be varied linearly between a start carrier frequency and an end carrier frequency during a chirp frame. This chirp pattern may be repeated one or more times in a chirp frame. Moreover, the chirp pattern may be repeated in subsequent chirp frames. In some embodiments, the chirp pattern may include: a sawtooth pattern, a triangle-wave pattern or a trapezoidal pattern. A triangle-wave pattern may allow the contributions in reflected or received optical signals associated with relative position and velocity of one or more objects in an environment to be separated or disambiguated. Note that the relative position and velocity in the received signals may be measured by beating the received signals with a transmit (or chirp) signal, which may result in a beat frequency that is proportional to the time delay of the received signals, a Doppler shift associated with relative velocity and a slope of the carrier frequency as a function of time.

One of the ingredients of an FMCW lidar system with good performance is linearity of an optical source of the optical transmit signals (such as a laser). For example, the nonlinearities needed to have a negligible penalty on the probability of detection and precision in the relative position (or range) and velocity are on the order of tens to a couple of hundred of parts per million of the chirp bandwidth.

In the disclosed circuit techniques, optical source (e.g., laser) linearization may be achieved by measuring the laser frequency using an interferometer, and by precompensating or predistorting an output (such as a digital-to-analog converter or DAC output) that drives the laser.

Optical transmit circuit 100 presents a general description of the circuit techniques. In FIGS. 1A and 1B, note that: blocks 110 may include components in the measurement device or system that are to be controlled; blocks 112 may include intermediate results; blocks 114 may include outputs of the circuit techniques; blocks 116 may include inputs that are used to configure the circuit techniques; bars 118 may include forks and joins that illustrate different options for the circuit techniques; and a remainder of the blocks and circles may include operations. Note that when one arrow enters and multiple arrows exit one of bars 118, it may signify that only one of the outputs may be used in a particular implementation of the circuit techniques. When multiple arrows enter one of bars 118 and one arrow exits it, it also may signify that only one of the inputs may be used in a particular implementation of the circuit techniques.

The components in the measurement device or system that are to be controlled may include a DAC that drives a modulation port of the laser through a signal conditioning block that performs functions, such as DC removal, anti-alias filtering, etc. Moreover, a coupler may take a sample of the laser output to measure the laser carrier frequency and close the feedback loop in optical transmit circuit 100. The coupler may also let through part of the laser beam or output optical signal, which may allow a remainder of the measurement device or system to work.

In some embodiments, the monitored optical signal may be measured in one of a variety of ways. For example, the laser or output optical signal may be input to one of a variety of interferometers. An optical beam splitter may split the output optical signal. Different delays may be applied in the two optical paths. Then, the optical signals may be combined and a photo diode may be used to measure the difference in frequency between the two optical signals. Ideally, the output of the interferometer may be a sine function.

In one approach, the monitored optical signal may be measured using a short real interferometer (such as up to a few centimeters) and a power tap. This monitored signal may need to be converted to a frequency signal as a function of time by performing: signal conditioning, correcting for power variations, compensating for nonlinearities, compensating the sin (x) function that the interferometer creates, etc. This short interferometer may be kept in quadrature (e.g., by controlling the frequency of the laser or by controlling the length of the interferometer). Note that in these embodiments the beat period may be 1 ms and the chirp period may be, e.g., 10 μs. Consequently, a sine wave output may occur for 0.01-0.1 of a full cycle, so the output of the interferometer may be linear (and, thus, an arctan function may not be needed to linearize the output of the interferometer). In some embodiments, the arctan function may be replaced with a polynomial approximation that is easier to compute or to implement.

Alternatively, the monitored optical signal may be measured using a long real interferometer (such as between several tens of centimeters and several meters). This monitored optical signal may also need to be conditioned. A Hilbert transform may be used to obtain the imaginary part of the monitored optical signal based at least in part on the real portion of the monitored optical signal. Then, the output of the Hilbert transform may be converted to a frequency signal as a function of time by a combination of: arctan functions, unwrapping of the phase, assigning slope signs, and scaling.

In some embodiments, the monitored optical signal may be measured using a complex interferometer (which may be short or long). For example, a long interferometer may have a beat period divided by a chirp period of 10-100. However, the long interferometer used in real and/or complex interferometry may be a couple of meters in length, which may be expensive to implement (e.g., using a delay line in silicon photonics) without power loss and/or may be computationally expensive. Note that a complex interferometer may be sensitive to a sign of a slope of the carrier-frequency pattern, while a real interferometer may measure or be sensitive to an absolute value of the slope of the carrier-frequency pattern.

Note that the complex interferometer may include two optical and analog paths to measure the real and the imaginary portions of the transmit optical signal. Then, the complex signal may be converted to a frequency signal as a function of time by: calculating an arctan function, unwrapping the phase, and scaling.

Note each of these approaches includes a signal conditioning operation in which signals are filtered and/or averaged over multiple chirp frames, etc.

Once the frequency signal as a function of time is obtained using one of the aforementioned options, the circuit techniques may use further processing. Notably, the frequency signal as a function of time may have a length that depends, at least in part on, the chirp frame length and the interferometer sampling frequency. This signal length may be converted to a second signal length that is convenient for performing an FFT using available hardware in optical transmit circuit 100 by performing interpolation. However, zero padding may or may not be used in this operation.

Once the interpolated frequency signal as a function of time is obtained, it may be subtracted from a target waveform. This target waveform may be the target frequency (an input of the circuit techniques) or a modified version of the target frequency (e.g., to round the edges).

This operation may improve the convergence of the circuit techniques and may avoid unnecessary high-frequency signals in the predistorted waveform.

After subtraction, the error signal may be obtained. Then, an FFT may be calculated on the error signal in order to measure a spectrum of the error signal.

Moreover, a DC component of the resulting signal may be discarded. Furthermore, at least some of the N complex terms of the FFT may be used for the circuit techniques (where N is a non-zero integer). In general, higher frequencies may not need to be tracked, but in some embodiments N may be as large as the number of coefficients in the FFT.

Additionally, N proportion-integral-derivative (PID) controllers or loops (which are sometimes referred to as ‘PID circuits’) may be run in parallel over these FFT coefficients. This may iteratively bring the time-average error of each frequency component (or bin) to zero. Note that the proportional coefficient (K_{P}), the integral coefficient (K_{I}) and/or the derivative coefficient (K_{D}) of some or all of the FFT coefficients (or bins) may be different.

An inverse FFT (iFFT) of the output of the N PIDs may be calculated to get a first version of the precompensation function. In some embodiments, the iFFT may calculated over a signal made up of the N outputs of the PIDs with zeros added to that signal. For example, the value corresponding to the DC component of the FFT may be replaced with zero before performing the iFFT.

In some embodiments, the FFT uses N out of the M bins of the FFT, where N and M are non-zero integers and N is less than or equal to M. For example, N may equal the number of PID controllers or loops. Moreover, when N is less than M, then when performing the iFFT all M bins may be used by filling the M-N bins with zeros.

Note that the DAC waveform may include a number of samples that is a function of the chirp frame length and the DAC sampling frequency. In some embodiments, interpolation may be performed in order to bring the iFFT output to the correct size.

Moreover, at this point, an initially predistorted waveform may be added. This may improve convergence of the circuit techniques. For example, a predistorted waveform from a previous instance or iteration of the circuit techniques may be added. Note that the previous instance or iteration of the circuit techniques may be determined during a calibration operation that is performed when fabricating the optical transmit circuit. Thus, the predistorted waveform may be stored in a register, a memory or a computer-readable medium.

Furthermore, scaling, DC offset and other DAC corrections may be performed. For example, a compensation of the DAC integral nonlinearity (INL) may be added at this point in optical transmit circuit 100. The result may be the DAC predistorted waveform that may be used by the DAC to drive the frequency modulation port of the laser or optical source.

In some embodiments, the circuit techniques may include: slope monitoring, conditioning of the target frequency as a function of time; calculation of the laser or optical source linearity; monitoring of the convergence of the linearization in the circuit techniques; and/or calculating K_{P}, K_{I} and K_{D} for each PID controller (or PID circuit). Slope monitoring may be used in order to have a good range accuracy. Notably, at the output of the frequency signal as a function of time, the slopes may be easily measured, e.g., by fitting one or more first-order polynomials to segments of the chirp frame that correspond to the most linear part of each slope (e.g., the central 90% of each slope).

Moreover, conditioning of the target frequency as a function of time may be used to reduce the high frequency component of the target frequency (e.g., a triangle-wave pattern has sharp edges that may be difficult for the laser or an optical source to track in direct modulation, thereby creating high-frequency components in the DAC predistorted waveforms). For example, in direct modulation, the injected current to or voltage applied to a laser or an optical source may be modulated to change excitations in the laser or the optical source.

Furthermore, at the error signal, either in time or frequency domain (e.g., upstream or downstream of the FFT), the laser linearity may be calculated. This functional safety (FUSA) may be used, e.g., because if laser or optical source linearity is poor, the performance may be degraded. Note that the laser linearity may trigger remedial action or at least some action by optical transmit circuit 100.

Additionally, at the output of the PID controllers, the convergence of the linearization in the circuit techniques may be monitored. When coefficients change less than a given amount per iteration, then optical transmit circuit 100 may have converged. This convergence criterion may be useful for managing optical transmit circuit 100, e.g., for controlling a transition from an ‘intensive initial linearization’ in which the laser or optical source is brought from nonlinear behavior to a well linearized state. When this occurs, control circuit 110 in optical transmit circuit 100 may transition to a slow monitoring or slow update mode, in which only minor corrections to the predistortion are performed. Alternatively, when optical transmit circuit 100 has converged and linearity is not good, optical transmit circuit 100 (such as control circuit 110) may take corrective or remedial action, such as: adjusting the PID coefficients, changing the target frequency signal, etc. Note that in some embodiments the PID controllers may converge within 1000 iterations.

In some embodiments, K_{P}, K_{I} and K_{D} may be calculated for each PID controller (so for each complex coefficient of the FFT). Optical transmit circuit 100 may start with initial values for K_{P}, K_{I} and K_{P}. Then, each frequency component may have its own loop gain and phase shift. The loop gains may be equalized, so that all the PID controllers converge at the same rate and/or all the PID controllers may be stable. Moreover, the phase shifts may need to be compensated in order to avoid actuating when a sine function produces a cosine function, etc., which may cause instability in optical transmit circuit 100 (and the measurement system in general). Furthermore, the loop gains and phase shifts may be monitored based at least in part on the convergence of the coefficients (e.g., if they rotate, then the phase may not be correct; alternatively, if they converge slower than others, then the gain may not be correct). In some embodiments, the loop gains and phase shifts may be calculated in an initial training phase. This training phase may include inserting arrays of all zeros except one value in the complex correction coefficients in the frequency-domain and/or setting the target frequency to zero. Then, optical transmit circuit 100 may measure the magnitude and phase of the error coefficients in the frequency domain.

Note that the numerical values listed in FIGS. 1A and 1B are illustrative examples. In other embodiments, different numerical values may be used. Moreover, the optical transmit circuit in FIGS. 1A and 1B may include fewer or additional components, two or more components may be combined into a single component, a single component may be implemented using two or more separate components, and/or a position of one or more components may be changed.

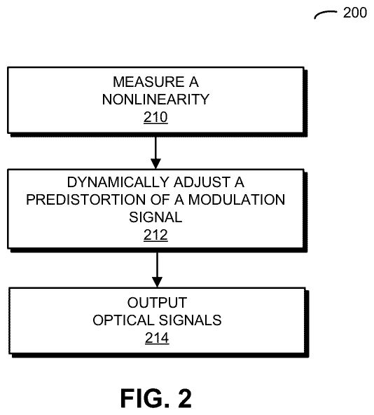

We now describe embodiments of a method. FIG. 2 presents a flow diagram illustrating an example of a method 200 for closed-loop adaptation of a modulation signal associated with an optical source and corresponding to a carrier-frequency pattern of optical signals, which may be performed by an optical transmit circuit (such as optical transmit circuit 100 in FIGS. 1A and 1B). During operation, an optical transmit circuit may measure a nonlinearity (operation 210) associated with the optical transmit circuit. Then, the optical transmit circuit may dynamically adjust, based at least in part on the measured nonlinearity, a predistortion in a modulation signal (operation 212) associated with an optical source and corresponding to a carrier-frequency pattern. Next, the optical transmit circuit may provide or output optical signals (operation 214) based at least in part on the dynamically adjusted modulation signal.

In some embodiments of method 200, there may be additional or fewer operations. Moreover, the order of the operations may be changed, and/or two or more operations may be combined into a single operation.

While the preceding discussion used direct modulation of an optical source or a laser in the optical transmit circuit or a measurement system as an illustrative example, in other embodiments the optical source or the laser may be modulated using a Mach-Zehnder interferometer (MZI). Moreover, while the preceding discussion illustrated the circuit techniques with operations performed in the frequency domain, in other embodiments at least some of the operations may be performed in the time domain (e.g., on a sample-by-sample basis).

The disclosed integrated circuit and the circuit techniques can be (or can be included in) any electronic device or system. For example, the electronic device may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, a vehicle, a ship, an airplane, a car, a truck, a bus, a motorcycle, manufacturing equipment, farm equipment, construction equipment, or another type of electronic device.

Although specific components are used to describe the embodiments of the integrated circuit, in alternative embodiments different components and/or subsystems may be present in the integrated circuit. Thus, the embodiments of the integrated circuit may include fewer components, additional components, different components, two or more components may be combined into a single component, a single component may be separated into two or more components, one or more positions of one or more components may be changed, and/or there may be different types of components.

Moreover, the circuits and components in the embodiments of the integrated circuit may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar. Note that electrical coupling or connections in the preceding embodiments may be direct or indirect. In the preceding embodiments, a single line corresponding to a route may indicate one or more single lines or routes.

As noted previously, an integrated circuit may implement some or all of the functionality of the circuit techniques. This integrated circuit may include hardware and/or software mechanisms that are used for implementing functionality associated with the circuit techniques.

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the circuit techniques may be implemented using program instructions that are executed by a processor or in firmware in an integrated circuit.

Moreover, while examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An integrated circuit, comprising:
an optical transmit circuit configured to output optical signals having a carrier-frequency pattern as a function of time, wherein a modulation signal, associated with an optical source and corresponding to the carrier-frequency pattern, comprises a predistortion to reduce a nonlinearity associated with the optical transmit circuit; and
a feedback circuit configured to measure the nonlinearity and that dynamically adjust the predistortion based at least in part on the measured nonlinearity.

2. The integrated circuit of claim 1, wherein the integrated circuit is configured to provide closed-loop adjustment of the predistortion.

3. The integrated circuit of claim 1, wherein the predistortion comprises direct modulation of a current or voltage associated with the modulation signal.

4. The integrated circuit of claim 1, wherein the feedback circuit is configured to measure a carrier frequency of the output optical signals as a function of time.

5. The integrated circuit of claim 1, wherein the feedback circuit comprises an interferometer.

6. The integrated circuit of claim 1, wherein dynamic adjustment of the nonlinearity is performed in the frequency domain.

7. The integrated circuit of claim 1, wherein the feedback circuit is configured to compare at least a portion of a band of frequencies associated with a Fourier Transform of the output optical signals to a target waveform.

8. The integrated circuit of claim 7, wherein the feedback circuit is configured to adjust the predistortion so that a time average of the comparison is zero.

9. A method for closed-loop adaptation of a modulation signal associated with an optical source and corresponding to a carrier-frequency pattern of optical signals, comprising:
by an optical transmit circuit:
measuring a nonlinearity;
dynamically adjusting, based at least in part on the measured nonlinearity, a predistortion in a modulation signal associated with the optical source and corresponding to the carrier-frequency pattern; and
providing the optical signals based at least in part on the dynamically adjusted modulation signal.

10. The method of claim 9, further comprising providing closed-loop adjustment of the predistortion.

11. The method of claim 9, wherein the predistortion comprises direct modulation of a current or voltage associated with the modulation signal.

12. The method of claim 9, wherein the method comprises measuring a carrier frequency of the output optical signals as a function of time.

13. An electronic device, comprising:
an integrated circuit, wherein the integrated circuit comprises:
an optical transmit circuit configured to output optical signals having a carrier-frequency pattern as a function of time, wherein a modulation signal, associated with an optical source and corresponding to the carrier-frequency pattern, comprises a predistortion to reduce a nonlinearity associated with the optical transmit circuit; and
a feedback circuit configured to measure the nonlinearity and that dynamically adjust the predistortion based at least in part on the measured nonlinearity.

14. The electronic device of claim 13, wherein the integrated circuit is configured to provide closed-loop adjustment of the predistortion.

15. The electronic device of claim 13, wherein the predistortion comprises direct modulation of a current or voltage associated with the modulation signal.

16. The electronic device of claim 13, wherein the feedback circuit is configured to measure the carrier frequency of the output optical signals as a function of time.

17. The electronic device of claim 13, wherein the feedback circuit comprises an interferometer.

18. The electronic device of claim 13, wherein dynamic adjustment of the nonlinearity is performed in the frequency domain.

19. The electronic device of claim 13, wherein the feedback circuit is configured to compare at least a portion of a band of frequencies associated with a Fourier Transform of the output optical signals to a target waveform.

20. The electronic device of claim 19, wherein the feedback circuit is configured to adjust the predistortion so that a time average of the comparison is zero.
